(19) United States
(12) Patent Application Publication
(10) Pub. No.: US 2019/0270301 A1
(43) Pub. Date: Sep. 5, 2019

(54) GRIPPER CARRIAGE. SHEET-PROCESSING MACHINE COMPRISING A GRIPPER CARRIAGE AND A RADIATION DRYER, AND METHOD FOR TRANSPORTING SHEETS

(71) Applicant: KOENIG & BAUER AG, Würzburg (DE)

(72) Inventor: Maik WALTER, Dresden (DE)

(21) Appl. No.: 16/320,109

(22) PCT Filed: Sep. 21, 2017
(86) PCT No.: PCT/EP2017/073895

§ 371 Date: Jan. 24, 2019

(30) Foreign Application Priority Data
Sep. 21, 2016 (DE) 10 2016 218 157.2

(51) Int. Cl. B41F 23/04; B41F 21/04; B65H 29/04

(52) U.S. Cl. CPC B41F 23/045; B41F 21/04; B65H 2801/31; B65H 2401/13; B65H 29/041

(57) ABSTRACT

A gripper carriage transports a sheet in a sheet transport direction along a sheet transport path. The gripper carriage has a wall and a reflector. The reflector is associated with a flank of the wall which is trailing, in relation to the sheet transport direction.

### CROSS REFERENCE TO RELATED APPLICATIONS

This application is the U.S. National Phase, under 35 U.S.C. § 371, of PCT/EP2017/073895, filed Sep. 21, 2017; published as WO 2018/055030 A1 on Mar. 29, 2018 and claiming priority to DE 10 2016 218 157.2, filed Sep. 21, 2016, the disclosures of which are expressly incorporated herein in their entireties by reference.

### FIELD OF THE INVENTION

The present invention relates to a gripper carriage, a sheet processing machine comprising a gripper carriage and an integrated radiation dryer, and a method for transporting sheets by means of gripper carriages in the delivery of a sheet processing machine.

### BACKGROUND OF THE INVENTION

A sheet delivery known from DE 296 16 235 U1 conveys the sheets with the aid of gripper carriages which are guided on circulating chains along a sheet transport path. The gripper carriages clamp the leading edges of the sheets and also pull them along the sheet transport path past the radiation dryer.

DE 10 2010 001 806 A1 discloses a delivery of a sheet processing machine having a gripper carriage which is movable along a sheet guide, wherein the contour of the gripper carriage can be adapted to a concave or convex sheet guide.

U.S. Pat. No. 4,530,495 A discloses a sheet processing machine having a radiation dryer, in which the trailing surface of a gripper carriage forms an angle of less than 90° with the sheet transport plane so as to decrease the area of the sheet that is not irradiated.

EP 0 252 602 A1 discloses a sheet processing machine having a radiation dryer, in which the gripper carriage has a reflector on its upper side for the purpose of shading the gripper carriage itself from direct radiation or reducing heat.

Since the gripper carriages jut outward from the plane in which they transport or convey the sheets and toward the radiation dryer, they shield at least the leading edge region of said sheets against a portion of the dryer radiation, in particular during the time when the sheets are approaching the radiation dryer. Regions of the sheets in which this shielding is intense enough to prevent satisfactory drying of the ink are not to be imprinted, since the ink might still smear in such regions or be transferred to other sheets after delivery or downstream of the delivery unit.

The resulting diminished drying may manifest itself as low abrasion resistance and/or low scratch resistance.

With today's steadily increasing machine speeds, a lightweight construction that offers high flexural strength especially in turning regions is a further requirement, which can be met in particular by specific gripper carriage profiles. One such gripper carriage profile is a T-shaped profile, for example; however, this type of profile throws a larger shadow on regions of the sheet near the gripper carriage.

From DE 103 04 617 A1, a sheet conveyor for a sheet processing machine is known, in which a gripper bar in the form of a carrier profile with belts is formed. The gripper bar in this case may be formed using a carrier profile from the group composed of C, S, double T, U or Z profiles.

### SUMMARY OF THE INVENTION

The object of the present invention is to provide an alternative gripper carriage or an alternative method for transporting sheets in the delivery of a sheet processing machine. A further object is to provide an alternative sheet processing machine having a radiation dryer and at least one gripper carriage.

The object is achieved according to the invention by the provision of a gripper carriage for transporting a sheet in a sheet transport direction along a sheet transport path. The gripper carriage has a wall and reflector. The reflector is assigned to a flank of the wall which is trailing with respect to the sheet transport direction. In a method for transporting sheets in the delivery of a sheet processing machine there is provided at least one radiation dryer which is arranged along a sheet transport path, and at least one gripper carriage. The gripper carriage is guided along the sheet transport path in order to transport a sheet in the sheet transport direction. The gripper carriage is provided having a reflector for the radiation admitted by the radiation dryer. The reflector is used for directing radiation emitted by the radiation dryer onto the sheet being transported by the gripper carriage.

The invention has the advantage that an alternative gripper carriage or an alternative method for transporting sheets in the delivery of a sheet processing machine is provided. Further provided is an alternative sheet processing machine having a radiation dryer and at least one appropriate gripper carriage.

According to a preferred embodiment, advantages may consist, in particular, in that the reflector diverts a portion of the dryer radiation, which in the absence of the reflector would be uselessly absorbed by the gripper carriage, onto the leading edge of a sheet being transported by the gripper carriage. This does not prevent the gripper carriage from shielding the sheet from irradiation by the radiation dryer before the gripper carriage reaches the radiation dryer. However, as soon as the gripper carriage has passed through the radiation dryer, the reflector reflects radiation that is emitted by the radiation dryer with at least one component in the sheet transport direction and that would not strike the sheet if its propagation were unimpeded, back toward the sheet, so that the leading edge of the sheet is irradiated more intensely once the shielding thereof by the gripper carriage is past.

To be effective over the entire width of the sheet, the reflector should preferably extend continuously over the entire width of the sheet transport path or the sheet transport plane. To reduce the redirection of the radiation transversely to the sheet transport direction, the reflector should preferably be straight or flat in profile, at least within a plane extending longitudinally along the gripper carriage, i.e. in a plane parallel to the leading edge of the sheet being transported by the gripper carriage.

The reflector may likewise be straight in a sectional plane orthogonal to the leading edge; however, a convexly curved or in particular a concavely curved cross-sectional shape may be useful there for optimizing radiation distribution. In a further embodiment, the reflector may also be configured as having a free-form surface. In particular, the reflector may have alternating concave and/or convex regions, for example.

A first segment may also be guided movably in the radial direction, for example, e.g. with the aid of tracks extending in a radial direction.

A particularly simple solution, with which an effective, homogeneous distribution of the radiation dose along the transport path and in particular in and/or opposite the sheet transport direction can be realized, involves aligning the reflector perpendicular to the sheet transport direction or perpendicular to a plane spanned by a gripper pad surface.

The reflectivity of the reflector for the radiation of the radiation dryer should be at least 40%, preferably at least 60%, in particular at least 75%. Such reflectivity, in particular such reflectance, can be achieved in the ultraviolet range (in particular, wavelengths of 220 nm to 400 nm) in particular by using an aluminum surface. The reflectivity of an aluminum-coated surface, such as a spring steel sheet, can be as much as 80%, for example.

To keep the aluminum surface oxide free, it should be provided with a protective coating. An oxygen-impermeable protective coating that is permeable to UV radiation from the dryer may contain silicon, more particularly it may be made of quartz.

### BRIEF DESCRIPTION OF THE DRAWINGS

Exemplary embodiments of the invention are illustrated in the set of drawings and will be described in greater detail below.

In the drawings:

FIG. 1 shows a schematic side view of a delivery having an integrated radiation dryer;

FIG. 2 shows a schematic cross-section of a gripper carriage of the delivery, entering the radiation dryer;

FIG. 3 shows the gripper carriage directly beneath the radiation dryer;

FIG. 4 shows the gripper carriage passing through the radiation dryer;

FIG. 5 shows a variant of the gripper carriage in a schematic cross-section;

FIG. 6 shows a reflector having four reflector elements for a gripper carriage for a delivery of a medium-format sheet-fed printing press;

FIG. 7 shows a rear view of the reflector having four reflector elements;

FIG. 8 shows a rear view of a gripper carriage with a reflector having five reflector elements for a delivery of a large-format sheet-fed printing press;

FIG. 9 shows a cross-section of the gripper carriage according to the preceding figure;

FIG. 10 shows a cross-section of a reflector having a screw connector;

FIG. 11 shows the reflector elements of the reflector for a gripper carriage of a large-format sheet-fed printing press;

FIG. 12 shows the reflector elements of the reflector with screw connectors.

### DESCRIPTION OF PREFERRED EMBODIMENTS

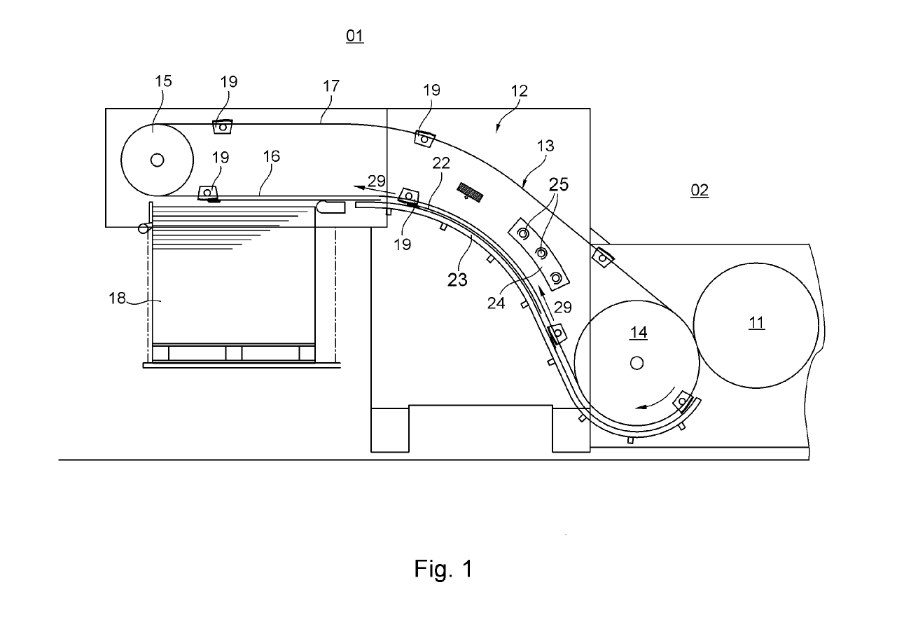

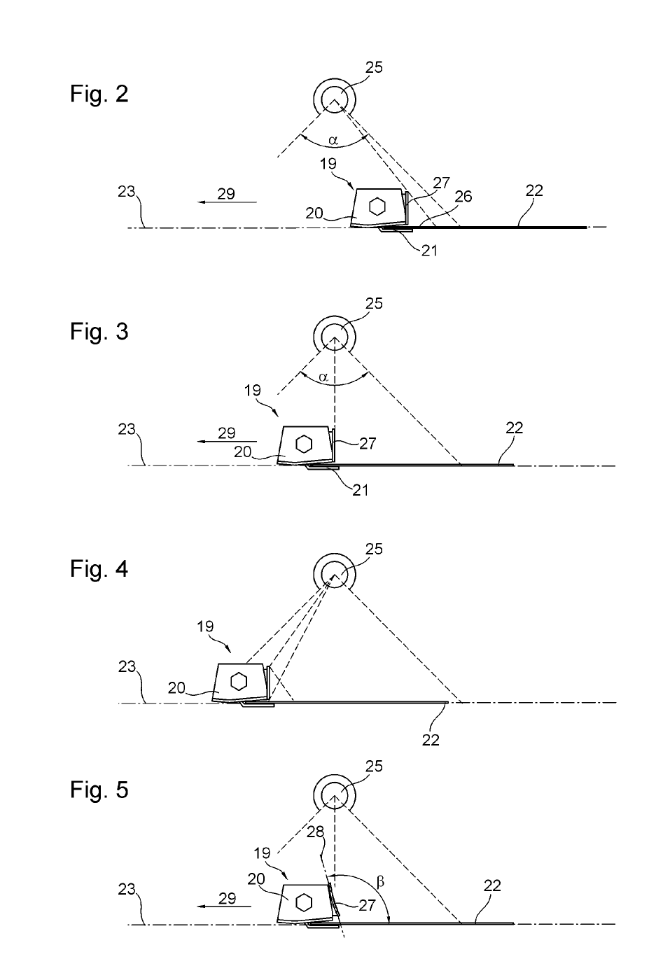

FIG. 1 shows a side view of a delivery 01 along with parts of the last printing unit 02 in a sheet processing machine, e.g. a sheet-fed printing press, in this case a sheet-fed offset printing press, preferably in a unit-based and inline configuration. Once the last printing ink has been applied to a sheet 22 in contact with a blanket cylinder, not shown, a printing cylinder 11 of the printing unit 02 transfers said sheet 22 to a sheet transport system 12 of the delivery 01. Alternatively, another unit, for example a coating unit, may transfer sheet 22 to the delivery 01 or to the sheet transport system 12. Sheet transport system 12 comprises two continuous chains 13, which are turned on sprockets 14, 15. Chain guides disposed on side frames of the delivery 01 guide a lower run and an upper run 16, 17 of the chains 13, each along a curved path from sprocket 14 to sprocket 15, initially ascending diagonally and then transitioning to horizontal above a delivery pile 18. Alternatively, the areas where the chains 13 are turned may be formed by turning guides. Gripper carriages 19, which serve as holding tools, are mounted evenly spaced on the chains 13. Each gripper carriage 19 comprises a gripper carriage body 20 which is elongated transversely to the sheet transport direction 29, i.e. the direction of travel of the chains 13 of the lower run 16, and is attached to both chains 13 (see, e.g. FIG. 2), along with movable gripper fingers 21 distributed along one edge of the gripper carriage 19, which are provided for clamping the leading edge of a sheet 22 on the printing cylinder 11, which has been imprinted on said cylinder, onto the gripper carriage 19, and for drawing said sheet 22 within a sheet transport plane or along a sheet transport path 23, which in this case corresponds to the pathway of the lower run 16, to the delivery pile 18, where it is released. The sheet transport path 23 may lead, for example, along sheet guiding elements, such as sheet guiding plates.

When sheet 22 is traveling along sheet transport path 23 in sheet transport direction 29, its side that was printed on printing cylinder 11 is facing upward. Facing this side and situated between the runs 16, 17 is at least one radiation dryer 24. Radiation dryer 24 comprises at least one radiation source 25 preferably extending over the entire width of the sheet transport plane or the sheet transport path 23 from one chain 13 to the other, with three radiation sources 25 being shown by way of example in FIG. 1. Since the number of radiation sources 25 is irrelevant to the functioning of the invention, only one is shown in FIGS. 2 to 5, in the interest of simplicity.

As an alternative or in addition to positioning the radiation dryer 24 in the sheet ascent area for the purpose of curing printing inks, a radiation dryer 24 may be positioned in a delivery extension. This delivery extension may be used to create a coating pathway segment downstream of a final unit, for example a coating unit or printing unit 02. The reflectors 27 (see below) on the gripper carriages 19 may also be used for coatings, in particular UV-curing coatings, for example. They may also be used with digital printing inks, in particular UV-curing digital printing inks.

Radiation dryer 24 or radiation source 25 preferably supplies UV radiation that is capable of inducing a chemical drying reaction in the ink and/or the coating that has been printed onto sheet 22. For physical drying, a radiation source that emits radiation in the visible or infrared or microwave spectrum is also possible. The radiation source 25, in particular the UV radiation source 25, may be embodied in particular as a mercury discharge lamp in the form of an elongated tube extending transversely to the sheet transport direction 29 or in the form of an arrangement of UV LED's on a carrier extending transversely to the sheet transport direction 29. The mercury discharge lamp emits radiation with equal intensity around essentially its entire axis in nearly all directions and is therefore typically combined with a reflector that limits such emission transversely to the axis to within an angular range α; based upon their structural configuration, the LED's emit radiation only within such a limited angular range α. The angular range α may be approximately 120°, for example, and/or a gripper carriage 19 may be guided beneath radiation source 25 with a vertical distance of approximately 10 mm between radiation source 25 and gripper carriage body 20.

When a gripper carriage 19 is approaching the radiation source 25, as shown in FIG. 2, the gripper carriage simultaneously shades a leading edge region 26 of the sheet 22 it is drawing behind it. This edge region 26 becomes narrower the closer the gripper carriage 19 comes to radiation source 25, while at the same time, the intensity of the radiation to which the sheet 22 beyond the shaded edge region 26 is exposed becomes increasingly higher. The total dose of radiation received by the sheet 22 by the time its leading edge reaches the position of maximum approach toward the radiation source 25, shown in FIG. 3, therefore decreases from the rear toward the leading edge.

To correct this uneven distribution, a reflector 27 is preferably disposed, in particular mounted, on a trailing flank 07, with respect to the sheet transport direction 29, of a wall of the gripper carriage 19, in particular on a flank 07 or surface of gripper carriage 19 oriented opposite the sheet transport direction 29. Reflector 27 may be a planar strip which extends along gripper carriage 19, preferably over the entire length of gripper carriage 19 or radiation source 25. Reflector 27 preferably extends over at least 80% of the width of the gripper carriage body 20 of gripper carriage 19 and/or over a width that is determined by the two outer gripper fingers 21 of gripper carriage 19 and/or the maximum width of a sheet 22 to be processed. It may be formed by a highly polished metal sheet; preferably, it comprises a layer of metal, in particular aluminum, applied, in particular vapor deposited, onto a flat substrate, and particularly preferably an air-tight protective layer, for example of quartz, covering the metal layer. A reflector 27 of this type has a reflectivity for the radiation of the radiation dryer 24, in particular for the UV radiation of the UV radiation source 25, of at least 40%, in particular at least 60%, preferably at least 75%. The reflectivity near the emitted wavelength is particularly preferably 80%.

Applied layer stacks (equivalent to the dichroic reflectors) of hafnium oxide and silicon oxide are another alternative. The thickness of the layers is appropriate for reflection within a certain wavelength range. The more layers of a given thickness are applied, the higher the reflectance. This enables the layer system to be constructed such that in addition to reflecting UV radiation and light (for curing-like the dichroic reflector in the UV module), IR radiation is reflected. This prevents the gripper carriage 19 from becoming heated by IR radiation. However, both variants are possible.

A part of gripper carriage 19, in particular a part of gripper carriage body 20, may also be formed as a reflector 27. In that case, a surface of gripper carriage 19, for example, in particular a surface of gripper carriage body 20, is embodied as having a low degree of roughness. This can be accomplished by mechanical processing and/or by coating, for example. In such processes, the coating is optimized in particular not only in terms of decreased roughness but also in terms of increased reflection. The property of reflection is material dependent, in particular; for example, chromium may be unsuitable. Reflector 27 may be configured as an adhesive strip, for example, in particular as an aluminum adhesive strip.

Reflector 27 may extend as a single integral piece or in multiple pieces along gripper carriage body 20, transversely to the sheet transport direction 29. For attaching said reflector, screw holes may be distributed along reflector 27; additional openings, which should occupy only a small portion of the reflector surface, may be provided for sensors that serve, for example, for monitoring the correct position and/or drying of sheet 22 on gripper carriage 19. Alternatively or additionally, reflector 27 may be attached by clamping and/or gluing.

A flat surface of reflector 27, or the reflector surface itself, preferably forms a reflector plane 28. In the embodiment shown here, reflector 27, in particular reflector plane 28, is at least nearly perpendicular to the sheet transport direction 29 and/or perpendicular to the sheet transport plane and/or perpendicular to sheet 22, or perpendicular to a plane spanned by a gripper pad surface 35 (see below). Deviations from this orientation are possible but must not exceed 30°. Reflector plane 28 may be understood, for example, as a spatial plane which is spanned by the surface of reflector 27.

At the moment when reflector 27 passes through the position of maximum approach toward radiation source 25, shown in FIG. 3, its reflective surface is struck by radiation from said radiation source. The portion of the radiation that strikes reflector 27 has been emitted by radiation source 25 with a component in the transport direction 29 of sheet 22, and if it had not been reflected, it would have passed through the sheet transport plane or through the sheet transport path 23 in front of the leading edge of sheet 22 or would have struck gripper carriage 19, and thus would not have been used. Due to reflector 27, this portion is also available and is reflected onto those areas of sheet 22 that were previously shaded. The additional dose thus obtained is at its highest particularly near the base of reflector 27, where sheet 22 was previously shaded most intensely and for the longest time. A uniform distribution of the radiation over nearly the entire length and/or width of sheet 22 can thereby be achieved, and sheet 22 can be printed and/or coated at least nearly up to or directly along its leading edge without fear of insufficient drying.

If a vertical reflector 27 arranged over the entire surface were to have a reflectivity of precisely 100%, then with a symmetrical radiation source 25, said reflector could compensate precisely for the shading by gripper carriage 19. To compensate for reflection losses, it would be conceivable for the reflector 27 to be embodied as concave in profile transversely to the longitudinal direction of gripper carriage 19, as depicted in FIG. 5, in order to achieve a focusing of the reflected radiation. In particular, reflector 27 is situated such that its reflector plane 28 or a tangent 28 applied to a curved reflector 27 intersects with the sheet transport plane or a plane spanned by a gripper pad surface 35. In particular, an extension of the reflective surface of reflector 27 extends substantially perpendicular to the plane spanned by gripper pad surface 35 and preferably transversely to the sheet transport direction 29.

Furthermore, by tilting reflector 27 forward, as shown in FIG. 5, in which case a tangent 28 applied to the curved reflector surface forms an obtuse angle □ with sheet 22, the radiation can be reflected predominantly into a region of sheet 22 that is not immediately adjacent to reflector 27. In this way, although a uniform distribution of the radiation dose on sheet 22 up to the base of reflector 27 is not achieved, the boundary up to which sufficient drying is achieved is nevertheless moved closer to gripper carriage 19, thereby increasing the printable area of sheet 22. In particular, reflector 27 can thus be situated such that the angle β formed between reflector plane 28 or a tangent 28 applied to a curved reflector 27, approximately centered on the vertical extension of said reflector with respect to a gripper pad surface 35 or the sheet 22, and a sheet 22 or a plane spanned by a gripper pad surface 35 is obtuse, in particular measuring between 91° and 120°, preferably at least approximately 93°. Accordingly, in the case of a free-form surface, at least some regions of reflector 27 are situated in this way. The angle □ could also be acute. In that case, the radiation would be reflected further toward the leading edge of the sheet. The angle □ in that case may measure between 60° and 89°, for example.

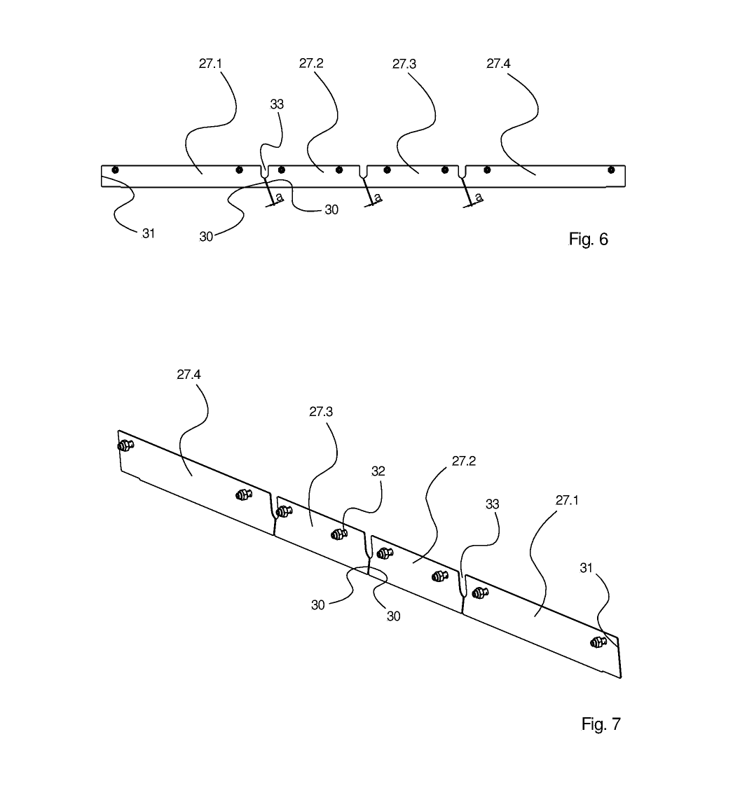

FIG. 6 shows a reflector 27 for a gripper carriage 19, in particular having four reflector elements 27.1, 27.2, 27.3, 27.4, preferably for a delivery of a medium-format sheet-fed printing press, for example. A medium-format sheet-fed printing press is capable of processing a sheet width of at least approximately 105 cm, for example. Each of the reflector elements 27.1, 27.2, 27.3, 27.4 can have a polished surface, for example, of a spring steel sheet coated with aluminum (Al) and silicon dioxide (SiO2). The reflection of reflector 27 or of the reflector elements 27.1, 27.2, 27.3, 27.4 is optimized in particular for a wavelength of about 220 nm to 500 nm. Reflection may also be optimized for LED UV with a peak at a wavelength of 385 nm. The reflector elements 27.1, 27.2, 27.3, 27.4 may also have an uncoated surface in the region of fastening elements, for example, at bores measuring about 15 mm in diameter. In the case of simple stainless steel sheets, for example, the reflectance of the reflector elements 27.1, 27.2, 27.3, 27.4 can be >=40% at 200 nm, >=50% at 225 nm, >=65% at 250 nm, and >=75% at 275 to 500 nm. Preferred aluminum coated surfaces will each have higher values.

Reflector 27, in particular the reflector elements 27.1, 27.2, 27.3, 27.4, are assigned to a flank 07 or surface of the wall of gripper carriage 19 which is trailing with respect to the sheet transport direction 29. The trailing flank 07 is therefore a flank or surface of gripper carriage 19 that faces the sheet 22 to be transported. The trailing flank 07 of the wall may merge continuously or discontinuously, for example, into an adjoining surface that comprises or forms the surface of gripper carriage 19 that faces away from the sheet transport plane, and this surface may further be connected to the leading flank of gripper carriage 19. However, the wall may also be formed by a panel of gripper carriage 19. In particular, the trailing flank 07 may be a surface arranged on a side of the wall in particular of a gripper carriage body 20 or a carrier body 20, which side faces away from a gripper shaft 09, and/or a surface aligned at least nearly parallel to the normal of the sheet transport plane or the normal of a plane spanned by a gripper pad surface 35.

Preferably, reflector 27 has at least two reflector elements 27.1, 27.2, 27.3, 27.4, in this case precisely four such reflector elements, which reflect radiation. These reflector elements 27.1, 27.2, 27.3, 27.4, in particular spaced apart from one another, are arranged transversely to the sheet transport direction 29 or parallel to the sheet leading edge. Each of the four reflector elements 27.1, 27.2, 27.3, 27.4, in particular, is assigned to the trailing flank 07 or surface of the wall of gripper carriage 19, transversely to the sheet transport direction 29. In particular, some or all of the reflector elements 27.1, 27.2, 27.3, 27.4 lie within a common plane, or the reflector elements 27.1, 27.2, 27.3, 27.4 are arranged within said common plane. One surface of reflector 27 or the surfaces of some or all of the reflector elements 27.1, 27.2, 27.3, 27.4 together form a reflector plane 28. Reflector plane 28 can be understood as a spatial plane.

In the case of a reflector 27 having multiple reflector elements 27.1, 27.2, 27.3, 27.4, these reflector elements 27.1, 27.2, 27.3, 27.4 are preferably arranged adjacent to one another via abutting edges 30. In that case, the reflector elements 27.1, 27.2, 27.3, 27.4 are arranged spaced from one another by a distance a, which preferably measures between 0.1 mm and 5 mm. Particularly preferably, the reflector elements 27.1, 27.2, 27.3, 27.4 are arranged spaced from one another by a distance a that measures at least approximately 1.5 mm. Reflector 27 or the reflector elements 27.1, 27.2, 27.3, 27.4 may also be equipped with recesses 33, which may also be provided, for example, in the region of the abutting edges 30 between the reflector elements 27.1, 27.2, 27.3, 27.4.

In particular, the spaced-apart reflector elements 27.1, 27.2, 27.3, 27.4 may have abutting edges 30 that deviate from the normal of the sheet transport plane or the normal of a plane spanned by a gripper pad surface 35, i.e. from the orthogonal to the sheet transport path 23. These abutting edges 30 of the reflector elements 27.1, 27.2, 27.3, 27.4 are aligned parallel to one another, in particular, and are preferably arranged lying within a common plane such that each is formed at an angle of 1° to 45° from the normal or the orthogonal of the sheet transport plane or the sheet transport path 23. Particularly preferably, at least two reflector elements 27.1, 27.2, 27.3, 27.4, and in this case particularly preferably all of said reflector elements, are formed with abutting edges 30 facing one another at an angle of at least approximately 20° from the normal of the sheet transport plane. Reflector 27, more particularly each of the two outer reflector elements 27.1, 27.4, which are arranged facing the chains 13, preferably has an external outer edge 31 which is aligned at least nearly parallel to the normal of the sheet transport plane or the normal of the plane spanned by a gripper pad surface 35.

FIG. 7 shows a rear view of the reflector 27, in particular having four reflector elements 27.1, 27.2, 27.3, 27.4, from the fastening side. Each reflector element 27.1, 27.2, 27.3, 27.4 preferably has at least two and particularly preferably precisely two fastening elements, by means of which said reflector element 27.1, 27.2, 27.3, 27.4 can be assigned directly or indirectly to the wall of a gripper carriage 19. The fastening elements may be embodied, in particular, as screw connectors 32. Each screw connector 32 may be formed by a screw, for example a size M6×16 screw, and a nut, assigned indirectly or directly to the wall of gripper carriage 19. The wall of gripper carriage 19 may be formed, for example, by a gripper carriage body 20 or a carrier body 20 or carrier bar, in particular formed transversely to the sheet transport direction 29. In that case, reflector 27 or a reflector element or relevant reflector element 27.1, 27.2, 27.3, 27.4 is assigned to a trailing flank 07, with respect to the sheet transport direction 29, of the gripper carriage body 20 or the carrier body 20.

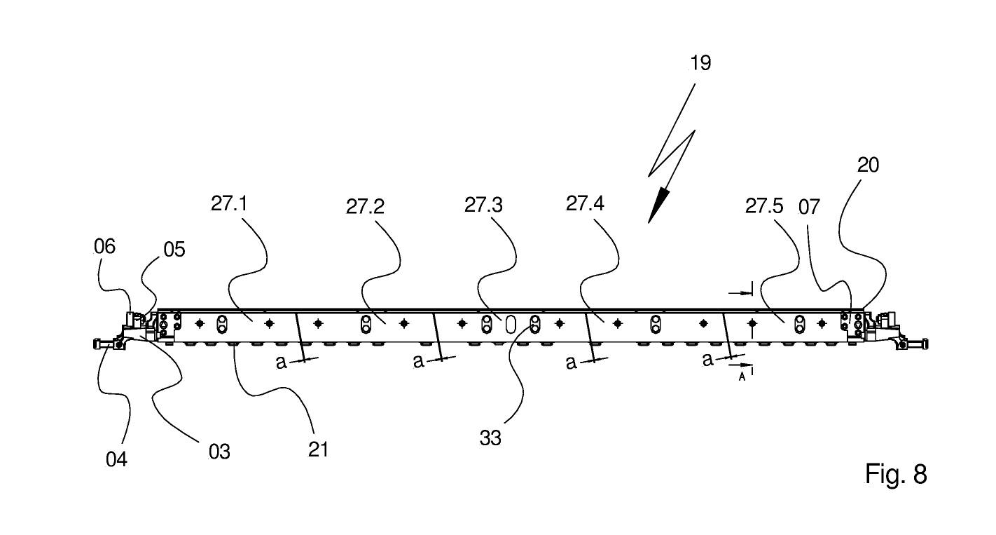

FIG. 8 shows a rear view of a gripper carriage 19 with a reflector 27 having five reflector elements 27.1, 27.2, 27.3, 27.4, 27.5, in particular, preferably for a delivery of a large-format sheet-fed printing press, for example. A large-format sheet-fed printing press is capable of processing a sheet width of at least approximately 145 cm to 205 cm, for example. Reflector 27, or a reflector element or relevant reflector element 27.1, 27.2, 27.3, 27.4, 27.5 is configured, in particular, to reflect ultraviolet radiation or for a wavelength range of 220 nm to 500 nm. Reflector 27 or a reflector element or relevant reflector element 27.1, 27.2, 27.3, 27.4, 27.5 may be configured as described above, for example.

Gripper carriage 19 is configured for transporting a sheet 22 in the sheet transport direction 29 within a sheet transport plane along the sheet transport path 23. Gripper carriage 19 has a wall, with the reflector 27 being assigned to a flank 07 of said wall which is trailing with respect to the sheet transport direction 29. Preferably, gripper carriage 19 includes a carrier body 20, in particular as a single integral piece, which is or can be disposed, preferably at both ends, on the chains 13 of the chain transport system 12 (not shown in further detail) via plates 03. Gripper carriage 19 can then be held and/or guided at each of its two ends via two pins 04 which are spaced apart from one another in the sheet transport direction 29 and are assigned to the plates 03. In particular, pins 04 may be part of the chains 13 of the sheet transport system 12. At one end or at both ends, gripper carriage 19 preferably further supports a roller lever 05, to which a cam follower 06 can be assigned. Via control means, such as control cams, the gripper fingers 21 of gripper carriage 19 can be controlled for clamping and releasing a sheet 22. In particular, by means of the control means, in particular control cams, and the roller levers 05 preferably each supporting a cam follower 06, gripper fingers 21 can be controlled for receiving and for releasing a sheet.

Preferably, reflector 27 has at least two, in particular precisely five reflector elements 27.1, 27.2, 27.3, 27.4, 27.5 that reflect radiation. These reflector elements 27.1, 27.2, 27.3, 27.4, 27.5, in particular spaced apart from one another, are arranged transversely to the sheet transport direction 29 or parallel to the sheet leading edge. In particular, each of the reflector elements 27.1, 27.2, 27.3, 27.4, 27.5 is assigned to the wall, in particular to the carrier body 20, of the gripper carriage 19, transversely to the sheet transport direction 29. More particularly, some or all of the reflector elements 27.1, 27.2, 27.3, 27.4, 27.5 lie within a common plane, or the reflector elements 27.1, 27.2, 27.3, 27.4, 27.5 are arranged within said common plane. Additionally, reflector 27 or a reflector element or relevant reflector element 27.1, 27.2, 27.3, 27.4, 27.5 can have at least one recess 33 for installation, adjustment, maintenance and/or cleaning work on the gripper carriage 19.

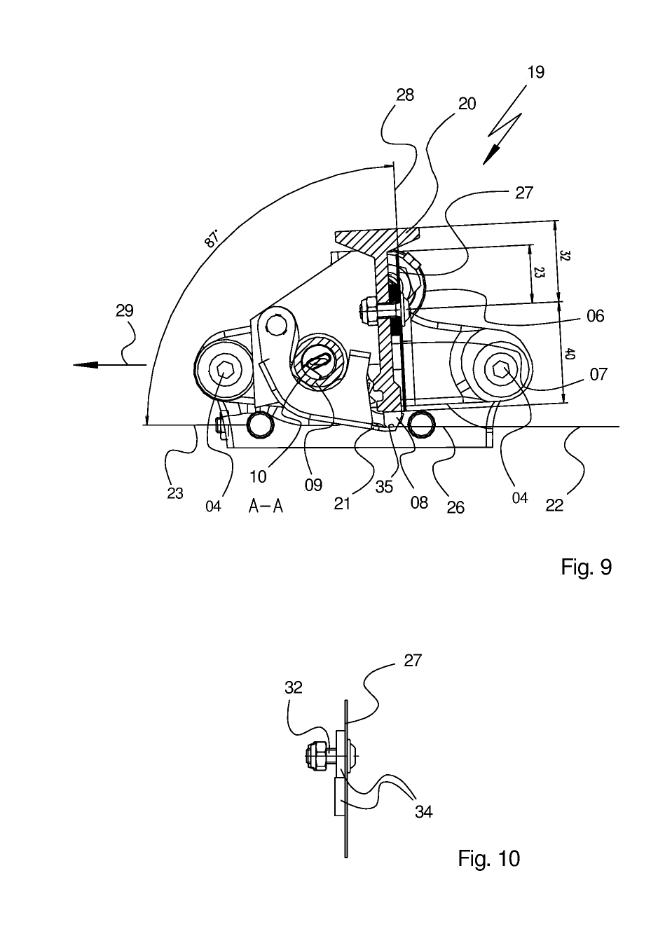

FIG. 9 shows a cross-section of gripper carriage 19 according to the previous figure. Here, gripper carriage 19 has a T-shaped carrier body 20, in particular, which is arranged transversely to the sheet transport direction 29 or parallel to the sheet leading edge, and in this case in particular forms the wall. The trailing flank 07 with respect to the sheet transport direction 29 is assigned to the reflector 27 or to a reflector element or relevant reflector element 27.1, 27.2, 27.3, 27.4, 27.5. The trailing flank 07 can thus be understood as the rear flank or rear surface of gripper carriage 19.

Gripper carriage 19 includes a gripper shaft 09, transversely to the sheet transport direction 29, which cooperates with gripper fingers 21 that are spaced from one another axially. Gripper shaft 09 is thus situated downstream of the wall, in particular the carrier body 20, with respect to the sheet transport direction 29. Gripper shaft 09 is therefore associated with the leading flank of the wall, in particular of the largely integral carrier body 20. Transversely to the sheet transport direction 29, gripper carriage 19 has at least one gripper pad 08, with each gripper pad forming a clamping nip with a movable gripper finger 21. An at least partially continuous strip having at least one gripper pad surface 35 may be used as gripper pad 08. Preferably, however, multiple individual gripper pads 08 with respective gripper pad surfaces 35 are used. The at least one gripper pad surface 35 or the gripper pad surfaces 35 span a plane that may correspond, for example, to the surface of the sheet 22 in the horizontal sheet transport path 23. The gripper pads 08 are assigned to carrier body 20 in the region of the sheet transport path 23.

Gripper shaft 09 is operatively connected at its end faces to the provided roller levers 05. When roller lever 05 supporting cam follower 06 is actuated, preferably by control means, the gripper fingers 21 can be controlled in relation to the gripper pads 08. Gripper shaft 09 can thereby actuate or move the gripper fingers 21 directly or via transmission means and thereby separate the gripper fingers 21 from the gripper pads 08. During sheet transport, the gripper fingers 21 are preferably pressed by one or more spring elements, for example a torsion spring 10, against the gripper pads 08 of the gripper carriage 19. Gripper carriage 19 may have a height perpendicular to the plane spanned by the gripper pad surfaces 35 of at least approximately 72 mm, for example, and the extension of reflector 27 or of a reflector element 27.1, 27.2, 27.3, 27.4, 27.5 or a relevant reflector element perpendicular to said plane may be at least approximately 63 mm.

Preferably, at least the trailing wall with respect to the sheet transport direction 29 is aligned at least nearly perpendicular to the sheet transport plane or to the sheet transport path 23 and/or transversely to the sheet transport direction 29. Therefore, reflector 27 or a reflector element 27.1, 27.2, 27.3, 27.4, 27.5 or relevant reflector element is preferably aligned at least nearly perpendicular to the sheet transport plane or to the sheet transport path 23 and/or transversely to the sheet transport direction 29. The wall may be part of a gripper carriage body 20 or part of the carrier body 20 of gripper carriage 19, for example. In particular, the wall may have a projection which is spaced and/or faces away from the sheet transport plane or from the sheet transport path 23, pointing or oriented opposite the sheet transport direction 29. In the region of the sheet transport plane, reflector 27 or a reflector element or relevant reflector element 27.1, 27.2, 27.3, 27.4, 27.5 is arranged, for example, flush with the wall, in particular with the carrier body 20. In this case, reflector 27, or a reflector element or relevant reflector element 27.1, 27.2, 27.3, 27.4, 27.5 may extend from at least nearly the sheet transport plane up to the projection of the carrier body 20. The projection of carrier body 20 may also project beyond reflector 27 or a reflector element or relevant reflector element 27.1, 27.2, 27.3, 27.4, 27.5, opposite the sheet transport direction 29.

One surface of reflector 27 or the surfaces of some or all of the reflector elements 27.1, 27.2, 27.3, 27.4, 27.5 together form a reflector plane 28. Reflector plane 28 can be understood as a spatial plane. The reflector elements 27.1, 27.2, 27.3, 27.4, 27.5 assigned to the trailing flank 07 of the wall, in particular of the support body 20, preferably have a common reflector plane 28, which forms an angle β with a sheet 22 gripped by gripper carriage 19 or with the plane spanned by the gripper pad surfaces 35. The angle β between reflector plane 28 and the sheet 22 or the spanned plane can measure between 60° and 120°, for example. Particularly preferably, the angle β formed between reflector plane 28 and a sheet 22 or the spanned plane is obtuse, i.e. measuring between 91° and 120°. In particular, the angle β between reflector plane 28 and sheet 22 or the spanned plane measures at least approximately 93°. In addition, gripper carriage 19 may be assigned adjustment means, for example for displacing reflector 27 or one or both outer reflector elements 27.1, 27.4, 27.5 so as to influence or optimize the reflected drying radiation. Further, at least one sensor for determining the position and/or the degree of drying of a sheet 22, 26 could be provided, optionally in conjunction with a control device.

FIG. 10 shows a cross-section of a reflector 27 with a fastening element, in particular a screw connector 32, for example as described above. Reflector 27 or a reflector element or relevant reflector element 27.1, 27.2, 27.3, 27.4, 27.5 may be assigned indirectly or directly to the wall, in particular the carrier body 20. For example, reflector 27 or a reflector element or relevant reflector element 27.1, 27.2, 27.3, 27.4, 27.5 may be assigned via a spacing means 34 to the wall, in particular to the carrier body 20. The spacing means 34 assigned to the fastening element, in particular the screw connector 32, may be embodied as inelastic or metallic, for example, for the purpose of fixation. The spacing means 34 arranged spaced from the fastening element may be configured, for example, as a damping means. In particular, a felt element may be used as a damping means. The damping means, in particular the felt element, may be assigned to one side or to both sides of the trailing flank 07 and/or the reflector 27, adhering thereto.

Reflector 27 or a reflector element 27.1, 27.2, 27.3, 27.4, 27.5 or relevant reflector element can also be assigned to the wall by means of an adhesive connection. Reflector 27 may also extend continuously over the entire width of the sheet transport path 23. Preferably, reflector 27 or a reflector element 27.1, 27.2, 27.3, 27.4, 27.5 or relevant reflector element can comprise an aluminum layer. Additionally, a protective layer may be provided over the aluminum layer. The protective layer can preferably contain silicon or quartz.

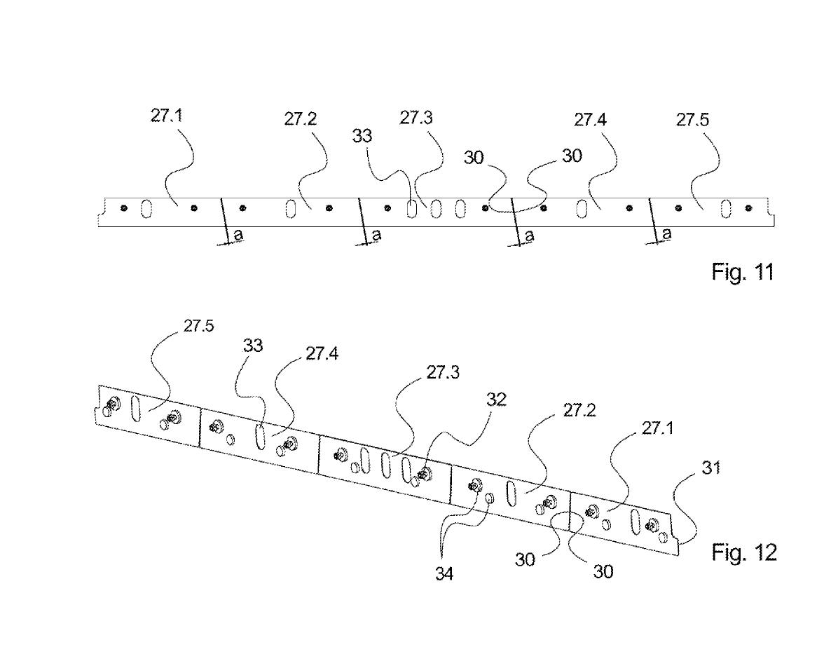

FIG. 11 shows reflector elements 27.1, 27.2, 27.3, 27.4, 27.5 of a reflector 27 for a gripper carriage 19, in particular for a large-format sheet-fed printing press. The reflector elements 27.1, 27.2, 27.3, 27.4, 27.5 are arranged spaced from one another by a distance a and are equipped with fastening elements. The reflector elements 27.1, 27.2, 27.3, 27.4, 27.5 are preferably arranged adjacent to one another via abutting edges 30. In particular, the reflector elements 27.1, 27.2, 27.3, 27.4, 27.5 are arranged spaced from one another by a distance a, the distance a measuring between 0.1 mm and 5 mm, for example. Particularly preferably, the reflector elements 27.1, 27.2, 27.3, 27.4, 27.5 are arranged spaced from one another by a distance a that measures at least approximately 1.5 mm.

In particular, reflector 27 can have reflector elements 27.1, 27.2, 27.3, 27.4, 27.5 spaced apart from one another, which have abutting edges 30 that deviate from the normal of the sheet transport plane or from the normal of a plane spanned by the gripper pad surfaces 35, i.e. from the orthogonal to the sheet transport path 23. These abutting edges 30 of the reflector elements 27.1, 27.2, 27.3, 27.4, 27.5 are aligned parallel to one another, in particular, and are preferably arranged lying within a common plane such that each is at an angle of 1° to 45° from the normal of the sheet transport plane or the spanned plane. Preferably, at least two reflector elements 27.1, 27.2, 27.3, 27.4, 27.5 and particularly preferably all of said reflector elements, are formed with abutting edges 30 facing one another at an angle of at least approximately 10° from the normal of the sheet transport plane. In that case, reflector 27 or each outer reflector element 27.1, 27.5 has an external outer edge 31 which is aligned at least nearly parallel to the normal of the spanned plane. Furthermore, reflector 27 or a reflector element or relevant reflector element 27.1, 27.2, 27.3, 27.4, 27.5 may have one or more recesses 33, which can also be assigned to an abutting edge 30 and/or outer edge 31.

FIG. 12 shows the reflector elements 27.1, 27.2, 27.3, 27.4, 27.5 of reflector 27 with fastening elements, from the side to be fastened. Preferably, reflector 27 or a reflector element or relevant reflector element 27.1, 27.2, 27.3, 27.4, 27.5 can be assigned by means of screw connector 32 to the wall, in particular to the carrier body 20. In that case, reflector 27 or a reflector element or relevant reflector element 27.1, 27.2, 27.3, 27.4, 27.5 has at least two and preferably precisely two fastening points or fastening elements, in particular such that said fastening points or fastening elements are arranged spaced from one another transversely to the sheet transport direction 29. Preferably, a relevant reflector element 27.1, 27.2, 27.3, 27.4, 27.5 is held by two screw connectors 32 spaced apart from one another transversely to the sheet transport direction 29.

Spacing means 33, for example, which may be assigned to the fastening elements, for example, in particular the screw connectors 32, and/or arranged separately, are assigned to reflector 27 or to a reflector element 27.1, 27.2, 27.3, 27.4, 27.5 or relevant reflector element. Here, said spacing means 33 assigned to the screw connectors 32 are washers made of steel, for example. The spacing means 33 spaced apart from the screw connectors 32 may be configured, in particular, as damping means, for example as adhesive felt elements. Alternatively, reflector 27 may be configured as an adhesive strip and assigned to the wall, in particular to a gripper carriage body 20 or carrier body 20. Gripper carriage 19 may also have a gripper carriage body 20, which can be coated in the region of the reflector 27 or a reflector element 27.1, 27.2, 27.3, 27.4, 27.5 or relevant reflector element. Reflector 27 or a reflector element 27.1, 27.2, 27.3, 27.4, 27.5 or relevant reflector element may also be part of the gripper carriage body 20.

A sheet processing machine preferably has at least one radiation dryer 24, 25 arranged along the sheet transport path 23 and at least one and preferably multiple gripper carriages 19. The one or more gripper carriages 19 transport a respective sheet 22 in the sheet transport direction 29 along the sheet transport path 23; the gripper carriages 19 are preferably similar in configuration. Each of the gripper carriages 19 preferably has a reflector 27 or one or more reflector elements 27.1, 27.2, 27.3, 27.4, 27.5 for reflecting the radiation emitted by the radiation dryer 24, 25, said reflector or reflector element(s) being assigned to a wall, in particular to a wall of a gripper carriage body 20 or carrier body 20. More particularly, the reflectors 27 are assigned to a flank 07, which is trailing with respect to the sheet transport direction 29, of the wall, in particular of the gripper carriage body 20 or carrier body 20, of a respective gripper carriage 19, such that said reflector reflects the radiation, emitted by the radiation dryer 24, 25 with at least one component in the sheet transport direction 29, opposite the sheet transport direction 29.

Each of the gripper carriages 19 may also have a projection which is spaced apart from and/or faces away from the sheet transport plane or the sheet transport path 23, and which shades the leading edge region 26 of the sheet 22 gripped by the gripper carriage 19, vertically beneath the radiation dryer 24, 25, from the radiation emitted by the radiation dryer 24, 25. In particular, reflector 27 or a reflector element or relevant reflector element 27.1, 27.2, 27.3, 27.4, 27.5 has a reflectivity of at least 40%, in particular at least 60%, preferably at least 75% for the radiation of the radiation dryer 24, 25. A preferably used polished spring steel sheet, which is coated with aluminum and provided with a silicon protective layer, can achieve a reflectivity of about 80%.

During the transport of sheet 22 in the delivery of a sheet processing machine by a respective gripper carriage 19, the radiation emitted by the radiation dryer 24, 25 is directed onto the sheet 22 being transported by gripper carriage 19. The radiation emitted by the radiation dryer 24, 25 is directed in particular directly and/or immediately onto the sheet 22 gripped by gripper carriage 19. In particular, the radiation emitted by the radiation dryer 24, 25 is directed onto the leading edge region 26 of the sheet 22 gripped by gripper carriage 19, so that this leading edge region 26 experiences increased drying.

While preferred embodiments of a gripper carriage, a sheet processing machine comprising a gripper carriage and a radiation dryer and methods for transporting sheets, all in accordance with the present invention, have been set forth fully and completely hereinabove, it will be apparent to one of skill in the art that various changes could be made thereto without departing from the true spirit and scope of the present invention which is accordingly to be limited only by the appended claims.

1-50. (canceled)

51. A gripper carriage for transporting a sheet (22) in the sheet transport direction (29) along a sheet transport path (23), wherein at least one radiation dryer (24, 25) is arranged along the sheet transport path (23), wherein the gripper carriage (19) has a wall (20) and a reflector (27), characterized in that the reflector (27) is assigned to a flank (07) of the wall (20) which is trailing with respect to the sheet transport direction (29), and in that the reflector (27) has a reflectivity of at least 40% for the radiation of the radiation dryer (24, 25).

52. The gripper carriage according to claim 51, characterized in that the reflector (27) comprises at least two or precisely two, three, four, five or more reflector elements (27.1, 27.2, 27.3, 27.4, 27.5) spaced apart from one another transversely to the sheet transport direction (29).

53. The gripper carriage according to claim 51, characterized in that the reflector (27) comprises reflector elements (27.1, 27.2, 27.3, 27.4, 27.5) spaced apart from one another, wherein abutting edges (30) of the reflector elements (27.1, 27.2, 27.3, 27.4, 27.5) deviate transversely to the sheet transport direction (29) from the normal of a plane spanned by a gripper pad surface (35).

54. The gripper carriage according to claim 51, characterized in that the reflector (27) or a reflector element (27.1, 27.2, 27.3, 27.4, 27.5) is assigned to the wall (20) via a spacing means (34) or a damping means.

55. The gripper carriage according to claim 51, characterized in that the reflector (27) or a reflector element (27.1, 27.2, 27.3, 27.4, 27.5) is assigned to the wall (20) by means of an adhesive connection, or the reflector (27) assigned to the wall (20) is itself configured as an adhesive strip.

56. The gripper carriage according to claim 51, characterized in that the reflector (27) or a reflector element (27.1, 27.2, 27.3, 27.4, 27.5) is configured to reflect ultraviolet radiation or for a wavelength range of 220 nm to 500 nm.

57. The gripper carriage according to claim 51, characterized in that the reflector (27) or a reflector element (27.1, 27.2, 27.3, 27.4, 27.5) has at least one recess (33) for installation, adjustment, maintenance and/or cleaning work on the gripper carriage (19).

58. The gripper carriage according to claim 51, characterized in that an angle (β) between a reflector plane (28) or a tangent (28) applied to a curved reflector (27) or a curved reflector element (27.1, 27.2, 27.3, 27.4, 27.5), approximately centered on the vertical extension of said reflector with respect to a gripper pad surface (35), and a sheet 22 or a plane spanned by a gripper pad surface (35) is obtuse or measures between 91° and 120° or is at least approximately 93°.

59. The gripper carriage according to claim 51, characterized in that the reflector (27) or a reflector element (27.1, 27.2, 27.3, 27.4, 27.5) comprises a spring steel sheet.

60. The gripper carriage according to claim 51, characterized in that the reflector (27) or a reflector element (27.1, 27.2, 27.3, 27.4, 27.5) comprises an aluminum layer and/or has a protective layer over an aluminum layer.

61. The gripper carriage according to claim 51, characterized in that the gripper carriage (19) has a gripper carriage body (20) and this gripper carriage body (20) is coated in the region of the reflector (27) or a reflector element (27.1, 27.2, 27.3, 27.4, 27.5), or the reflector (27) or a reflector element (27.1, 27.2, 27.3, 27.4, 27.5) is part of the gripper carriage body (20).

62. A sheet processing machine having at least one radiation dryer (24, 25), located along a sheet transport path (23), and at least one gripper carriage (19), wherein the gripper carriage (19) is guided along the sheet transport path (23) in order to transport a sheet (22) in the sheet transport direction (29) and wherein the gripper carriage (19) has a wall (20) and a reflector (27), characterized in that the reflector (27) is assigned to a flank (07) of the wall (20) such that the reflector reflects radiation that is emitted by the radiation dryer (24, 25) with at least one component in the sheet transport direction (29) in a direction opposite the sheet transport direction (29), and in that the reflector (27) has a reflectivity of at least 40% for the radiation of the radiation dryer (24, 25).

63. The sheet processing machine according to claim 62, characterized in that the gripper carriage (19) has a projection spaced apart and/or facing away from a gripper pad surface (35), which projection shades a leading edge region (26) of the sheet (22) gripped by the gripper carriage (19) vertically beneath the radiation dryer (24, 25) from the radiation emitted by the radiation dryer (24, 25).

64. A method for transporting sheets in the delivery of a sheet processing machine that includes at least one radiation dryer (24, 25), arranged along a sheet transport path (23), and at least one gripper carriage (19), wherein the gripper carriage (19) is guided along the sheet transport path (23) in order to transport a sheet (22) in the sheet transport direction (29), and wherein the gripper carriage (19) has a reflector (27) for the radiation emitted by the radiation dryer (24, 25), characterized in that the reflector (27) directs radiation emitted by the radiation dryer (24, 25) onto the sheet (22) being transported by the gripper carriage (19), and in that the reflector (27) has a reflectivity of at least 40% for the radiation of the radiation dryer (24, 25).

65. The method according to claim 64, characterized in that the reflector (27) directs radiation emitted by the radiation dryer (24, 25) onto a leading edge region (26) of the sheet (22) gripped by the gripper carriage (19).
